(19) United States
(12) Patent Application Publication
(10) Pub. No.: US 2010/0328260 A1
(43) Pub. Date: Dec. 30, 2010

(54) CAPACITIVE TOUCHPAD OF MULTIPLE OPERATIONAL MODES

(75) Inventors: YEN-CHANG CHIU, LINKOU TOWNSHIP (TW); YUNG-LIEH CHIEN, TAOYUAN CITY (TW); I-HAU YEH, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: ELAN MICROELECTRONICS CORPORATION, HSINCHU (TW)

(21) Appl. No.: 12/814,645

(22) Filed: Jun. 14, 2010

Related U.S. Application Data
(63) Continuation-in-part of application No. 11/130,108, filed on May 17, 2005, now Pat. No. 7,768,503.

(51) Int. Cl. G06F 3/045

(52) U.S. Cl. 345/174

(57) ABSTRACT

A capacitive touchpad provides multiple operational modes including at least a key input mode, a handwriting input mode, and a mouse control mode. To switch the capacitive touchpad between the operational modes, a first pattern is defined as a mode switch for users to touch thereon. For each operational mode, specific second patterns are defined for indication of their corresponding functions, and several regions are defined corresponding to the positions of the second patterns to receive touch input from the second patterns.

### CROSS REFERENCE TO RELATED APPLICATION

This application is a continuation-in-part application of U.S. patent application Ser. No. 11/130,108, filed May 17, 2005 and entitled “Capacitive Touchpad Integrated with a Graphical Input Function.”

### FIELD OF THE INVENTION

The present invention is related generally to a capacitive touchpad and, more particularly, to a capacitive touchpad of multiple operational modes.

### BACKGROUND OF THE INVENTION

Touchpads have been well known and widely used in various electronic products. A touchpad could serve as a simple, light and low-cost pointing device, such as one in a notebook for mouse control.

FIG. 5 shows a perspective diagram for illustrating the operational principles of a capacitive touchpad, which comprises an insulation plate 48, a ground plane 36, a layer of Y trace 38, and a layer of X trace 40, and the later three are all coupled to a control circuit 46. An equivalent capacitor 42 exists between a Y trace 38 and the ground plane 36, and an equivalent capacitor 44 exists between an X trace 40 and the ground plane 36. When a finger or a conductive object touches on the insulation plate 48, upon the instant capacitance variation resulted therefrom, the control circuit 46 could determine the location of the finger or conductive object and a further processing accordingly.

Currently, there are three types of touchpad, i.e., resistive touchpad, electromagnetic touchpad, and capacitive touchpad. The capacitive touchpad has been applied in Internet public telephone and guiding system, but not provided with the functions of graphical input and handwriting input. The resistive touchpad has been applied in personal digital assistant (PDA) and electronic dictionary for example, but incapable of acquiring an input with fingers lightly touching thereon. Current tablet PC and electronic schoolbag are equipped with touchpad having handwriting input and key input functions integrated together, but only the resistive and electromagnetic touchpads are available for those applications. However, the resistive touchpad requires a concentrated pressing point for input thereon and thus is readily wear out, and the electromagnetic touchpad requires a special and battery-powered input pen for operations therewith.

In view of performance and cost, the capacitive touchpad is evidently superior to the resistive and electromagnetic touchpads. The operational principles of the capacitive touchpad reside in that an instant capacitance effect resulted from the touch of a finger or a conductive object on the touchpad is used to determine the touching location. Unlike the electromagnetic touchpad, the capacitive touchpad does not need to be operated with the aid of a power-consuming input pen, and the capacitive touchpad has a longer lifetime than the resistive touchpad, since there is no need for a concentrated pressing point thereon for input. Additionally, the capacitive touchpad has simpler construction, less elements and higher yield rate, and therefore the cost for mass production is lower.

Therefore, it is desired a touchpad having smaller volume, lower cost, and easier manipulation, and multiple operational modes.

### SUMMARY OF THE INVENTION

An object of the present invention is to provide a capacitive touchpad of multiple operational modes.

A capacitive touchpad according to the present invention provides several operational modes that may includes a key input function, a handwriting input function, and a mouse control function. The capacitive touchpad includes a first pattern defined as a mode switch to switch the capacitive touchpad between the operational modes, several second patterns defined in a manner corresponding to each of the operational modes for operation, and a panel for receiving touch input and being defined with several regions in a manner corresponding to each of the operational modes and its corresponding second patterns. In the handwriting input mode, a handwriting region is defined for handwriting input, and a recognition module automatically detects completion of the input trace within the handwriting region based on subsequent occurrence of a response time initiated upon a cessation of the input trace.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a perspective diagram of a capacitive touchpad according to the present invention;

FIG. 1A shows a perspective diagram of the capacitive touchpad in FIG. 1 under a graphical input mode;

FIG. 1B shows a perspective diagram of the capacitive touchpad in FIG. 1 under a key input mode;

FIG. 1C shows a perspective diagram of the capacitive touchpad in FIG. 1 under a handwriting input mode;

FIG. 1D shows a perspective diagram of the capacitive touchpad in FIG. 1 under a mouse control mode;

FIG. 2 shows a perspective diagram of a capacitive touchpad applied in a mobile phone according to the present invention;

FIG. 3 shows a perspective diagram of a capacitive touchpad equipped with a backlight source according to the present invention;

FIG. 4 shows a perspective diagram of a capacitive touchpad equipped with a frontlight source according to the present invention;

FIG. 5 shows a perspective diagram for illustrating the operational principles of a capacitive touchpad;

FIG. 6 shows a perspective diagram of a capacitive touchpad applied in a remote controller according to the present invention; and

FIG. 7 illustrates an embodiment of capacitive touchpad according to the present invention, which uses multiple light guide films for showing patterns thereon.

### DETAILED DESCRIPTION OF THE INVENTION

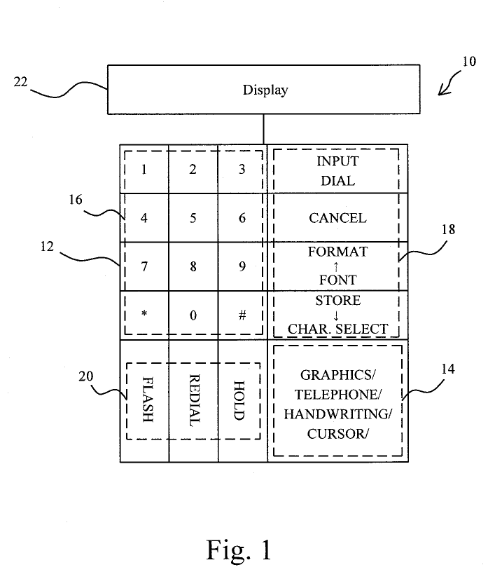

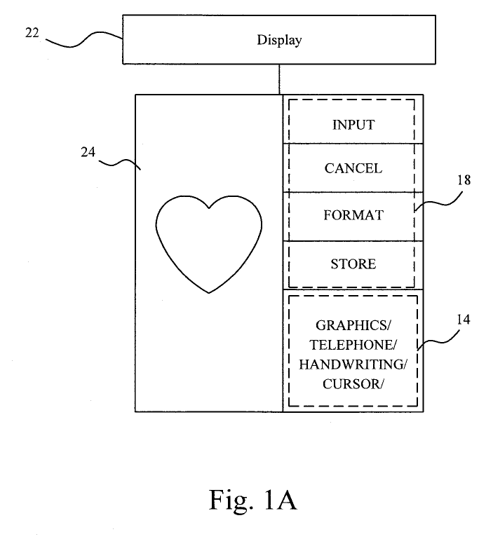

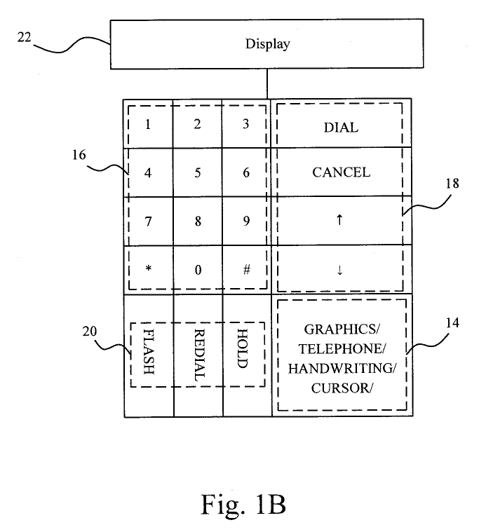

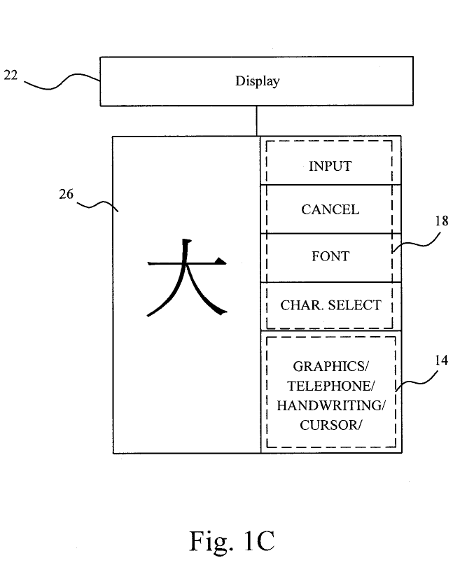

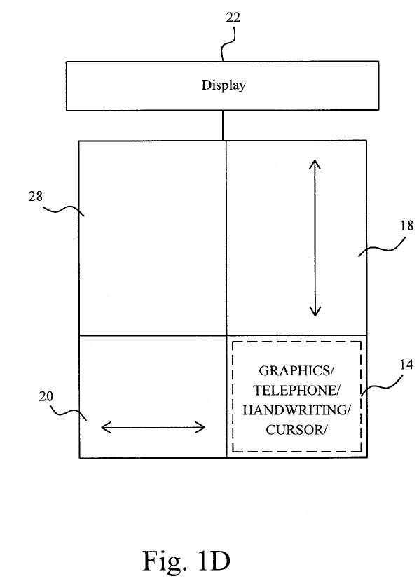

FIG. 1 shows a perspective diagram of an embodiment according to the present invention. A capacitive touchpad 10 comprises a panel 12 to be touched by fingers or conductive objects for input operations. On the panel 12, a pattern 14 is programmed as a mode switch to be touched to switch the capacitive touchpad 10 between a graphical input mode, a key input mode, a handwriting input mode, and a mouse control mode, and several regions 16, 18 and 20 are programmed for the input operations in the various operational modes. A display 22 is further coupled to the panel 12 to display the data inputted on the operational regions 16, 18 and 20, or the current operational mode.

When the capacitive touchpad 10 is switched to the graphical input mode, the regions 16 and 20 become a graphical input region 24, as shown in FIG. 1A, and in combination with the patterns INPUT, CANCEL, FORMAT, and STORE in the region 18 for the commands of input, cancel, format and store, the graphical input is carried out. In this mode, the user could draw graphics on the region 24 by fingers or conductive objects, the graphics inputted on the region 24 may be displayed on the display 22, and edited by operating on the region 24 and sent out to a host.

When the capacitive touchpad 10 is switched to the key input mode, as shown in FIG. 1B, the patterns of numeric, ‘#’ and ‘*’ in the region 16, the patterns of DIAL, CANCEL and upward as well as downward arrows in the region 18, and the patterns of FLASH, REDIAL and HOLD in the region 20, are used to serve as a keyboard for a telephone. With this virtual keyboard implemented by the panel 12, the user could dial up telephone numbers by touching the respective patterns on the panel 12, and the inputted telephone numbers may be displayed on the display 22 and sent out.

When the capacitive touchpad 10 is switched to the handwriting input mode, the regions 16 and 20 become a handwriting region 26, as shown in FIG. 1C, and in combination with the patterns INPUT, CANCEL, FONT and CHAR. SELECT in the region 18 for input, undo, and font and character selection, the user may operate for handwriting input. By writing on the handwriting region 26 with fingers or conductive objects, and with the aid of software or hardware for trace identification, the handwritten input such as words, numbers and symbols may be displayed on the display 22.

Significant difference is presented between the handwriting input mode and the graphical input mode. In the handwriting input mode, when the user stops to write on the handwriting region 26 for a while, the recognition module of the system will automatically recognize the trace on the handwriting region 26 for the input, and the response time to determine the handwriting input may be adjusted upon the user's request. While in the graphical input mode, it is a command issued by the user to complete the graphical input and to send out the inputted graphics to the system.

As the capacitive touchpad 10 is switched to the mouse control mode, as shown in FIG. 1D, the region 16 becomes a cursor control region 28 on which the user may control the movement of the cursor on a window, the region 18 becomes a vertical scroll region, and the region 20 becomes a horizontal scroll region. The vertical and horizontal roll regions 18 and 20 are used to control the scroll bars on a window, for example on a Microsoft Office application.

Moreover, another recognition module may be added to the system to identify the number of fingers touching on the cursor control region 28, to accordingly give various commands upon the number of fingers. For instance, with the determination of the recognition module to the finger number, a touching of two fingers on the panel 12 represents a click on the left button of a mouse, and a touching of three fingers on the panel 12 represents a click on the right button of a mouse.

FIG. 2 shows a perspective diagram of the capacitive touchpad 10 applied in a mobile phone 30, on which, by operating on the panel 12 as shown in FIGS. 1A-1D, various input modes may be achieved. To switch between the various input modes, the user only needs to touch on the pattern representative of the mode switch. For example, after completing an input including text and graphics on the panel 12, the user may switch the touchpad to the handwriting input mode to name and store a file for the input. In the handwriting input mode, by writing a filename on the panel 12, the user may call the stored file to edit and use. In addition to have the mobile phone 30 dramatically thinner in thickness, a significant improvement to the input functions is also obtained for the mobile phone 30. Furthermore, in terms of the cost, it is relatively cheaper than a key module in a conventional mobile phone.

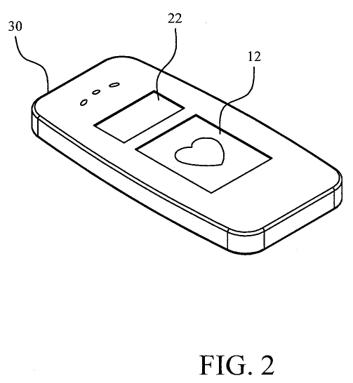

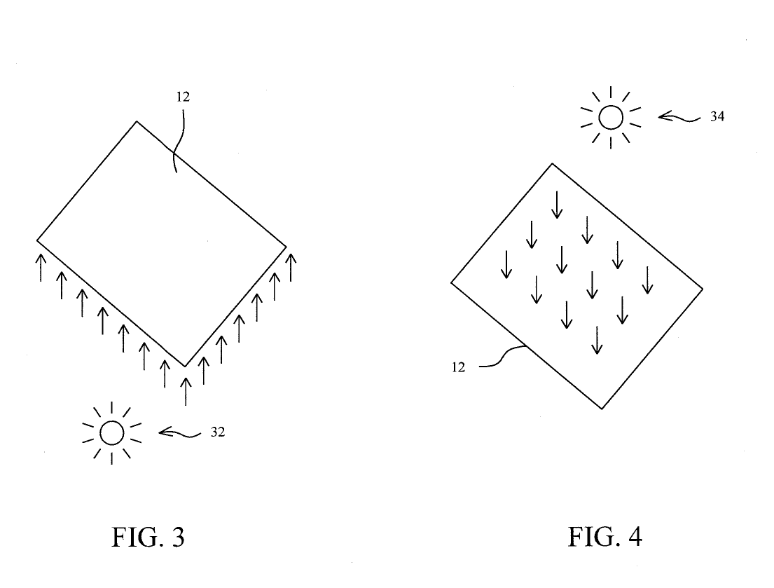

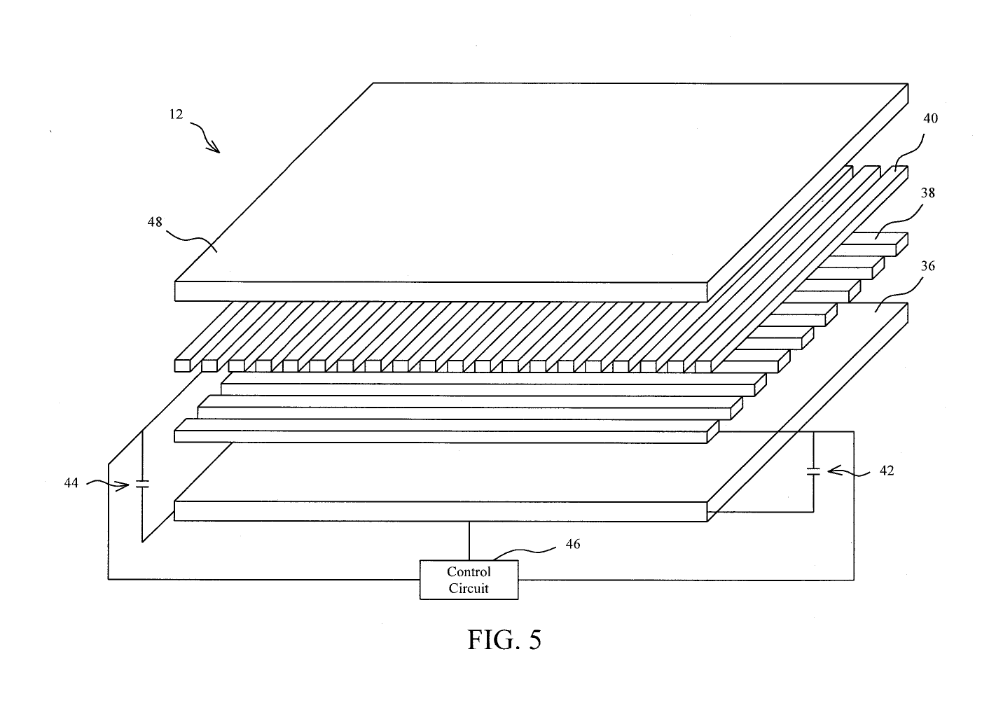

FIGS. 3 and 4 are perspective diagrams to show the capacitive touchpad 10 equipped with an additional light source, such that it is advantageous to use for situations with insufficient environmental light. FIG. 3 shows a condition that the panel 12 is made of transparent material such as glass, in which a backlight source 32 is used to project to the panel 12 from the backside thereof in order to illuminate the patterns on the panel 12. In FIG. 4, a frontlight source 34 is used to project to the panel 12 from the frontside thereof in order to illuminate the patterns on the panel 12.

Typically, the patterns for the virtual keys are printed on or attached to the insulation plate 48 of the panel 12. However, other amendments or modifications may be made without departing from the spirit of the present invention illustrated by the embodiments.

All user operations may be achieved without the further need for two devices of a mouse and a keyboard, provided that a capacitive touchpad of the present invention is applied in an electronic apparatus operated on a Windows operating system. Therefore, advantages of small volume and low cost over the electronic apparatus installed with mouse and keyboard may further appear.

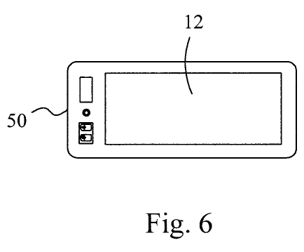

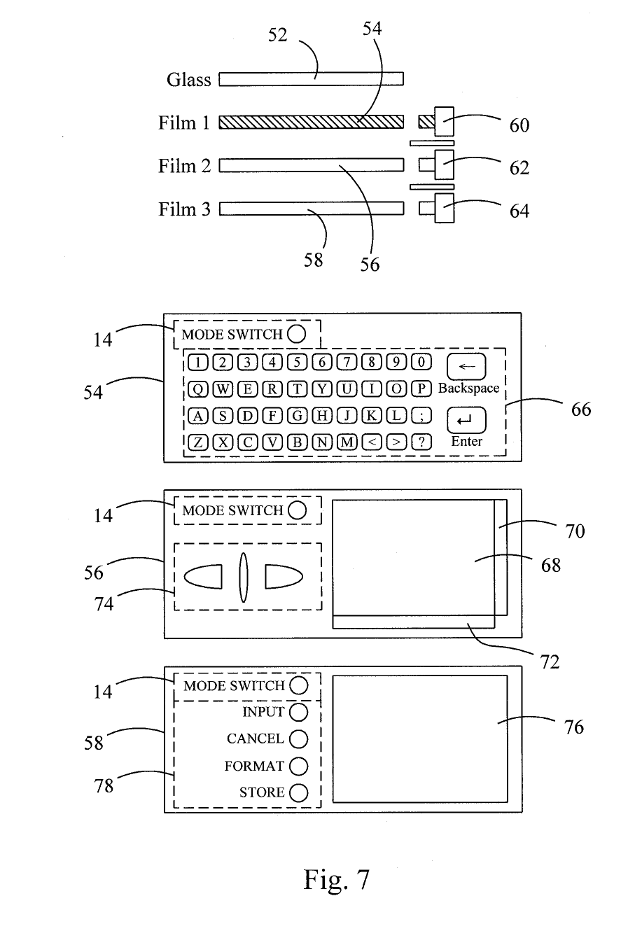

FIG. 6 shows a perspective diagram of a capacitive touchpad applied in a remote controller 50, which has a panel 12 for receiving touch input, and FIG. 7 illustrates an embodiment of the capacitive touchpad using multiple light guide films for showing patterns thereon. In this embodiment, as shown in FIG. 7, the capacitive touchpad includes a glass 52 as a substrate and three thin films 54, 56 and 58 beneath the glass 52 for serving as light guiding and diffusion elements based on refraction principle. The thin films 54, 56 and 58 are connected with side-emitting light-emitting elements 60, 62 and 64, respectively, and have several patters thereon. For example, as shown in the lower part of FIG. 7, the thin film 54 has patterns for operation in a key input mode, the thin film 56 has patterns for operation in a mouse control mode, and the thin film 58 has patterns for operation in a handwriting input mode. Depending on which operational mode is selected, the corresponding one of the light-emitting elements 60, 62 and 64 will provide light for its connected thin film 54, 56 or 58 to show the patterns thereon from the panel 12. For instance, when the capacitive touchpad is switched to the key input mode, only the light-emitting element 60 functions to render the patterns on the thin film 54 visible and therefore, as shown by the patterns on the thin film 54, keys for basic symbols, numerals and English letters will be shown from the panel 12, and the capacitive touchpad is defined with two regions 14 and 66 for receiving touch input from the mode switch button and the keypad, respectively. When the capacitive touchpad is switched to the mouse control mode, it is defined with regions 14, 68-74, and only the light-emitting element 62 functions to render the patterns on the thin film 56 visible and therefore, a mode switch button in the region 14, a window pattern in the region 68, vertical and horizontal scroll bar patterns in the regions 70 and 72, and mouse wheel and button patterns in the region 74 will be shown from the panel 12 for operation. When the capacitive touchpad is switched to the handwriting input mode, it is defined with regions 14, 76 and 78, and only the light-emitting element 64 functions to render the patterns on the thin film 58 visible and therefore, a mode switch button in the region 14, a writing pad pattern in the region 76, and several button patterns in the region 78 will be shown from the panel 12. In any operational mode, to switch the capacitive touchpad to another operational mode, the user only needs to touch on the mode switch button. In each operational mode, the capacitive touchpad is defined with specific regions for the current operation mode to receive touch input. All the patterns on the thin films 54-58 are only for indication of their corresponding functions, and may be referred as virtual buttons, virtual keys, or any other virtual control means, so that users will be convenient to operate the capacitive touchpad.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A capacitive touchpad comprising:
a first pattern defined as a mode switch to switch the capacitive touchpad between a plurality of operational modes including at least a key input mode, a mouse control mode, and a handwriting input mode;
a plurality of second patterns defined in a manner corresponding to each of the operational modes; and
a panel for receiving touch input and being defined with a plurality of regions in a manner corresponding to each of the operational modes and its corresponding second patterns;
wherein an input trace from the handwriting input mode is recognized by a recognition module, and the recognition module automatically detects completion of the input trace based on subsequent occurrence of a response time initiated upon a cessation of the input trace.

2. The capacitive touchpad of claim 1, further comprising a display for displaying the corresponding second patterns in a current operational mode.

3. The capacitive touchpad of claim 1, further comprising a display for displaying a data inputted on the panel or a current operational mode.

4. The capacitive touchpad of claim 1, further comprising a light source for providing light such that the second patterns become viewable from a frontside of the panel.

5. The capacitive touchpad of claim 4, wherein the light source is in front of the panel.

6. The capacitive touchpad of claim 4, wherein the light source is at the back of the panel.

7. The capacitive touchpad of claim 1, wherein the first pattern is on a thin film in the capacitive touchpad.

8. The capacitive touchpad of claim 7, further comprising a light-emitting element connected to the thin film for providing light to the thin film to thereby show the first pattern from the panel.

9. The capacitive touchpad of claim 1, wherein the second patterns are on a plurality of thin films in the capacitive touchpad in a manner that each of the operational modes has its corresponding second patterns on a respective one of the thin films.

10. The capacitive touchpad of claim 8, further comprising a plurality of light-emitting elements, each of which is connected to a respective one of the thin films for providing light thereto to thereby show the second patterns thereon from the panel.
